(19) United States
(12) Patent Application Publication
(10) Pub. No.: US 2008/0281104 A1
(43) Pub. Date: Nov. 13, 2008

(54) Membrane-Anchoring Fluorescent Probe

(75) Inventors: Tetsuo Nagano, Tokyo (JP); Hirotatsu Kojima, Tokyo (JP); Takashi Osaki, Gunma (JP)

Correspondence Address: GREENBLUM & BERNSTEIN, P.L.C., 1950 ROLAND CLARKE PLACE, RESTON, VA, 20191, US

(73) Assignee: THE UNIVERSITY OF TOKYO, Tokyo (JP)

(21) Appl. No.: 11/817,609

(22) PCT Filed: Mar. 3, 2006
(86) PCT No.: PCT/JP2006/304054

§ 371 Date: Jul. 17, 2008

Related U.S. Application Data
(60) Provisional application No. 60/658,177, filed on Mar. 4, 2005.

(51) Int. Cl. C07F 9/6558

(52) U.S. Cl. 546/22

(57) ABSTRACT

A membrane anchoring-type fluorescent probe consisting of a compound comprising a phospholipid residue, a fluorescent probe compound residue, and a linker which binds the residues (e.g., the compound represented by the following formula).

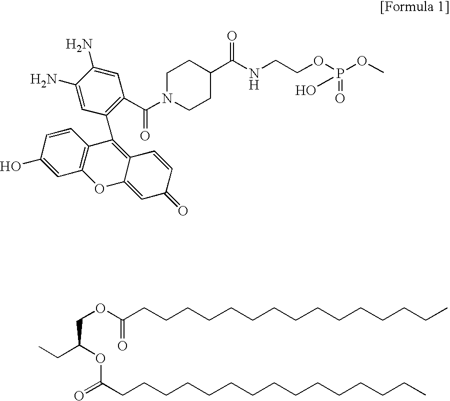

### TECHNICAL FIELD

The present invention relates to a membrane anchoring-type fluorescent probe fixable on a cell membrane.

### BACKGROUND ART

Various fluorescent probes that can measure nitric oxide, zinc ion, and the like in cells or tissues have been developed. The fluorescent probes developed so far have been designed to emit fluorescence on the capture of intracellular substances or on the change of electric potential. However, because of the property of the fluorescent probes per se that they can freely move thorough the cell membrane or between cells intercellularly, they have a problem that movement of a target substance from inside to outside of cells and movement of the intercellular signal transduction substance cannot be observed.

### DISCLOSURE OF THE INVENTION

### Object to be Achieved by the Invention

An object of the present invention is to provide a fluorescent probe by which the movement of a target substance from inside to outside of a cell or the movement of an intercellular signal transduction substance can be observed.

### Means for Achieving the Object

The inventors of the present invention conducted various researches to achieve the aforementioned object. As a result, they found that a compound comprising a fluorescent probe, which the fluorescent probe is bound via a linker with an anchor moiety capable of being embedded in a cell membrane, was efficiently fixed on the cell membrane, and that the probe functioned very desirably as a class of fluorescent probe fixable on a cell membrane (hereafter referred to a “membrane anchoring-type” in the specification) without degradation of characteristic features of the fluorescent probe moiety of the aforementioned compound fixed on the cell membrane. The present invention was accomplished on the basis of the aforementioned findings.

The present invention thus provides a membrane anchoring-type fluorescent probe consisting of a compound comprising a phospholipid residue, a fluorescent probe compound residue, and a linker which bind the residues.

Viewed from another aspect, the present invention provides a method for measuring the movement of a target substance from inside to outside of a cell by using the aforementioned membrane anchoring-type fluorescent probe, and a method for measuring the movement of the target substance as an intercellular signal transduction substance by using the aforementioned membrane anchoring-type fluorescent probe.

### BRIEF DESCRIPTION OF THE DRAWINGS

FIG. 1 shows a HPLC chart (left graph) and fluorescence intensity change (right graph) observed when a nitric oxide solution was added to DAF-PIPA.

FIG. 2 shows the fluorescence intensity time-course during the reaction between DAF-PIPA and NO, obtained by adding a nitric oxide releasing agent NOC13 to the DAF-PIPA.

FIG. 3 shows the pH profile of DAF-PIPA-T.

FIG. 4 shows photographs of HeLa cells loaded with FL-PIP-DPPE. The left is a confocal microphotograph, and the right is a photograph showing an image obtained by superimposing a transmitted light image on the confocal microphotograph.

FIG. 5 shows a photograph and a graph representing the changes in fluorescence intensity according to the extracellular pH change observed in HeLa cells loaded with FL-PIP-DPPE. The left photograph is a microphotograph at t=0 (sec.), and the right graph shows the time course of fluorescence intensity when the pH was changed from 7.4 to 6.7, and then to 6.4 at t=90 (sec.) and t=230 (sec.), respectively.

FIG. 6 shows photographs and a graph representing a function of DAF-PIP-DPPE as a nitric oxide fluorescent probe on HeLa cell membranes. In the figure, a) and b) are fluorescence microphotographs ((a) for t=0 sec., (b) for t=2800 sec.), and c) is a graph showing the time course of fluorescence intensity when 100 μmol/L and 1 μmol/L of NOC13 was added at t=120 (sec.) and 1800 (sec.), respectively.

### BEST MODE FOR CARRYING OUT THE INVENTION

The membrane anchoring-type fluorescent probe of the present invention is characterized in that a phospholipid residue and a fluorescent probe compound residue are bound via a linker.

The fluorescent probe compound is not particularly limited so long as the compound is used as a fluorescent probe for measurement of a target substance. Target substance is not particularly limited in type, and may be any of proteins, enzymes (for example, reductases, oxidases, hydrolases, and the like such as β-lactamase, cytochrome P450 oxidase, β-galactosidase, β-glucosidase, β-glucuronidase, β-hexosaminidase, lactase and alkaline phosphatase), metal ions (for example, alkali metal ions such as sodium ion and lithium ion; alkaline earth metal ions such as calcium ion; magnesium ion; zinc ion and the like), nonmetallic ions (carbonate ion and the like), active oxygen species (for example, nitric oxide, hydroxy radical, singlet oxygen, superoxide and the like), and the like. Preferred examples include, for example, nitric oxide, and the like.

The fluorescent probe compound has a group capable of detecting the presence of a target substance, such as a group that captures a target substance, a group that reacts with a target substance, or a group that is cleaved upon contact with a target substance; and the structure thereof is not particularly limited so long as the compound has a property of changing fluorescence intensity, for example, the property of increasing fluorescence intensity after detection of a target substance. As the fluorescent probe compound, various compounds have so far been proposed which comprise fluorescein, rhodamine, 4,4-difluoro-1,3,5,7-tetramethyl-4-bora-3a,4a-diaza-s-indacene (BODIPY, registered trademark, 505/515, Molecular Probes) or the like as a fundamental skeleton. However, the fluorescent probe compounds are not limited to these examples, and various kinds of fluorescent probes can be utilized. Further, as a group which can detect the presence of a target substance, wide varieties of groups including 3,4-diaminophenyl group (reagent for nitric oxide measurement) and the like are known.

For example, the fluorescent probe compounds described in Japanese Patent Laid-Open Publication (KOKAI) No. 10-226688, International Patent Publications WO99/1447, WO99/51586, Japanese Patent Laid-Open Publication No. 2000-239272, International Patent Publications WO01/62755, WO01/64664, WO02/18362, International Patent Applications PCT/JP2004/13185, PCT/JP2005/2753, Analyst, 128, 719-723 (2003), and the like can be used for the present invention. Further, the substituents for capturing a target substance described in the catalogue of Molecular Probes (Handbook of Fluorescent Probes and Research Chemicals, Ninth Edition), Chapter 20 (calcium ion, magnesium ion, zinc ion, and other metal ions), Chapter 21 (pH indicators), and Chapter 23 (sodium ion, potassium ion, chlorine ion, and other inorganic ions) can also be used. The entire disclosure of these publications are incorporated by reference into the disclosure of the present application. As a fluorescent probe compound for measurement of nitric oxide, for example, diaminofluorescein (DAF, Japanese Patent Laid-Open Publication No. 10-226688) or the like may preferably be used.

In this specification, the “fluorescent probe compound residue” is a residue obtained by eliminating an appropriate atom such as hydrogen atom or an appropriate functional group such as hydroxyl group or a halogen atom from a fluorescent probe compound, and preferably means a monovalent group. For example, a residue obtained by eliminating hydroxyl group from carboxyl group in 2-carboxyphenyl group of fluorescein or a fluorescein derivative is preferred.

The type of the phospholipid is not particularly limited, for example, phosphatidylethanolamines, phosphatidylcholines, phosphatidylserines, phosphatidylinositols, phosphatidylglycerols, cardiolipins, sphingomyelins, ceramide phosphorylethanolamines, ceramide phosphorylglycerols, ceramide phosphorylglycerol phosphates, 1,2-dimyristoyl-1,2-deoxyphosphatidylcholines, plasmalogens, phosphatidic acids, and the like can be used as the phospholipid.

The aliphatic acid residue in these phospholipids is not particularly limited. For example, a phospholipid having one or two saturated or unsaturated aliphatic acid residues each having about 12 to 20 carbon atoms can be used, and specifically, a phospholipid having one or two acyl groups derived from an aliphatic acid such as lauric acid, myristic acid, palmitic acid, stearic acid, oleic acid, and linoleic acid can be used. Among those mentioned above, phosphatidylethanolamines are preferred, and particularly preferred is dipalmitoylphosphatidylethanolamine (DPPE).

A phospholipid residue means a group obtained by eliminating an appropriate atom such as hydrogen atom, or an appropriate functional group such as hydroxyl group or a halogen atom from the aforementioned phospholipid or a chemically modified phospholipid; preferably a monovalent group. Examples include a residue obtained by eliminating hydrogen atom from hydroxyl group in phosphoric acid moiety of a phospholipid, a residue obtained by eliminating hydroxyl group of phosphoric acid moiety of a phospholipid, a residue obtained by eliminating hydrogen atom binding to a carbon atom of a phospholipid, or when amino group exists in a phospholipid, a residue obtained by eliminating hydrogen atom from the amino group, and the like. However, such a phospholipid residue is not limited to those mentioned above.

The type of the linker is not particularly limited, for example, it is preferable to use a linker having about 4 to 6 atoms as the number of atoms along the shortest length constituting the linker. In the specification, the term “the number of atoms along the shortest length” means the minimum number of atoms that can connect two atoms which are each involved in binding of the residue of a phospholipid or the residue of a fluorescent probe compound. For example, the number of atoms along the shortest length is 3 in the case of 1,3-propenylene group, 2 in the case of 1,2-propenylene group, 5 in the case of 1,5-(4-butoxy-3-pentenylene) group, 3 in the case of 1,3-phenylene group, 2 in the case of 1,2-phenylene group, 3 in the case of 2,4-quinolinediyl group, and 4 in the case of 1,5-naphthylene. Further, the number is 4 in ethylenedioxy group, 3 in malonyl group, and 4 in phthaloyl group.

As an example of the membrane anchoring-type fluorescent probe of the present invention, a fluorescent probe for measuring nitric oxide is shown below. However, the scope of the present invention is not limited to the particular target substance. It is preferable to use diaminofluorescein (DAF) or the like as the fluorescent probe compound, and the structure thereof is shown below. However, the scope of the present invention is not limited to the following specific compound. In the following formula, the residue of a fluorescent probe compound is a residue obtained by eliminating the hydroxyl group from the carboxyl group of DAF, the phospholipid residue is a residue obtained by eliminating hydrogen atom from the end amino group of dipalmitoylphosphatidylethanolamine (DPPE), and the 4-carbonylpiperidine moiety corresponds to the linker moiety.

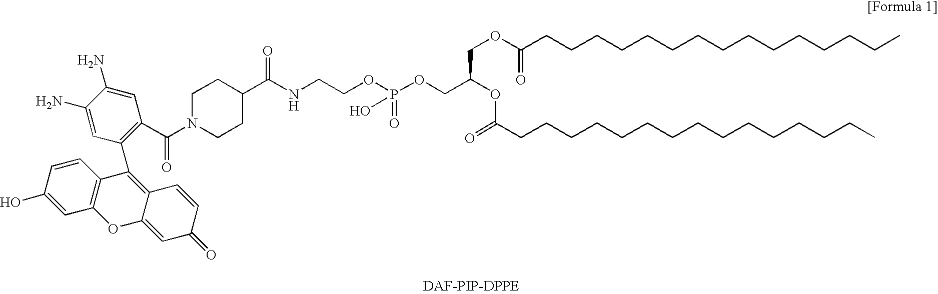

The membrane anchoring-type fluorescent probe of the present invention has a characteristic feature that fluorescence intensity thereof changes after the detection of a target substance, for example, even the probe per se not having a property of emitting strong fluorescence, emits strong fluorescence in the presence of a target substance. Further, the membrane anchoring-type fluorescent probe has a characteristic feature that the probe can be fixed on an outer surface of a cell membrane by embedding the anchor moiety (phospholipid moiety) in the outside part of a cell membrane of a living cell. Therefore, the membrane anchoring-type fluorescent probe of the present invention is useful as a fluorescent probe for measuring the movement of a target substance from inside to outside of a cell, or the movement of an target intercellular signal transduction substance. When the membrane anchoring-type fluorescent probe of the present invention is administered in a living cell by microinjection or other means, the anchor moiety (phospholipid moiety) can be embedded in a intracellular membrane tissue. The membrane anchoring-type probe is thus fixed on the intracellular membrane tissue, and therefore the membrane anchoring-type fluorescent probe of the present invention is useful as a fluorescent probe for measuring, near the intracellular membrane, the movement of a target substance and the movement of an target intercellular signal transduction substance. As the target substance, especially preferred are an intercellular signal transduction substance released extracellularly from a cell, such as nitric oxide (NO) and glutamic acid, and a substance which functions intracellularly near a membrane. The term “measurement” used in this specification should be construed in the broadest sense including quantitative and qualitative measurements.

The method for using the membrane anchoring-type fluorescent probe of the present invention is not particularly limited, and the probe can be used in the same manner as that for conventionally known fluorescent probes. Generally, the membrane anchoring-type fluorescent probe may be dissolved in an aqueous medium such as physiological saline and buffers; a mixture of a water-miscible organic solvent such as ethanol, acetone, ethylene glycol, dimethyl sulfoxide and dimethylformamide and an aqueous medium; or the like. Subsequently, the resulting solution may be added to an appropriate buffer containing cells or tissues, and then a fluorescence spectrum may be determined. The membrane anchoring-type fluorescent probe of the present invention can also be used in the form of a composition in combination with a suitable additive. For example, the probe can be combined with additives including buffering agents, dissolving aids, pH modifiers, and the like. It is also possible to use the membrane anchoring-type fluorescent probe of the present invention as a component lipid of lipid microparticles such as liposomes to prepare fluorescent probe-bound liposomes or the like, and to bring the prepared microparticles in the form of an aqueous suspension into contact with living cells, or administer them to a mammal including human as a reagent for in vivo measurement.

### EXAMPLES

The present invention will be more specifically explained with reference to the following examples. However, the scope of the present invention is not limited to the following examples.

### Example 1

### Preparation of Membrane Anchoring-Type Fluorescent Probe of the Present Invention

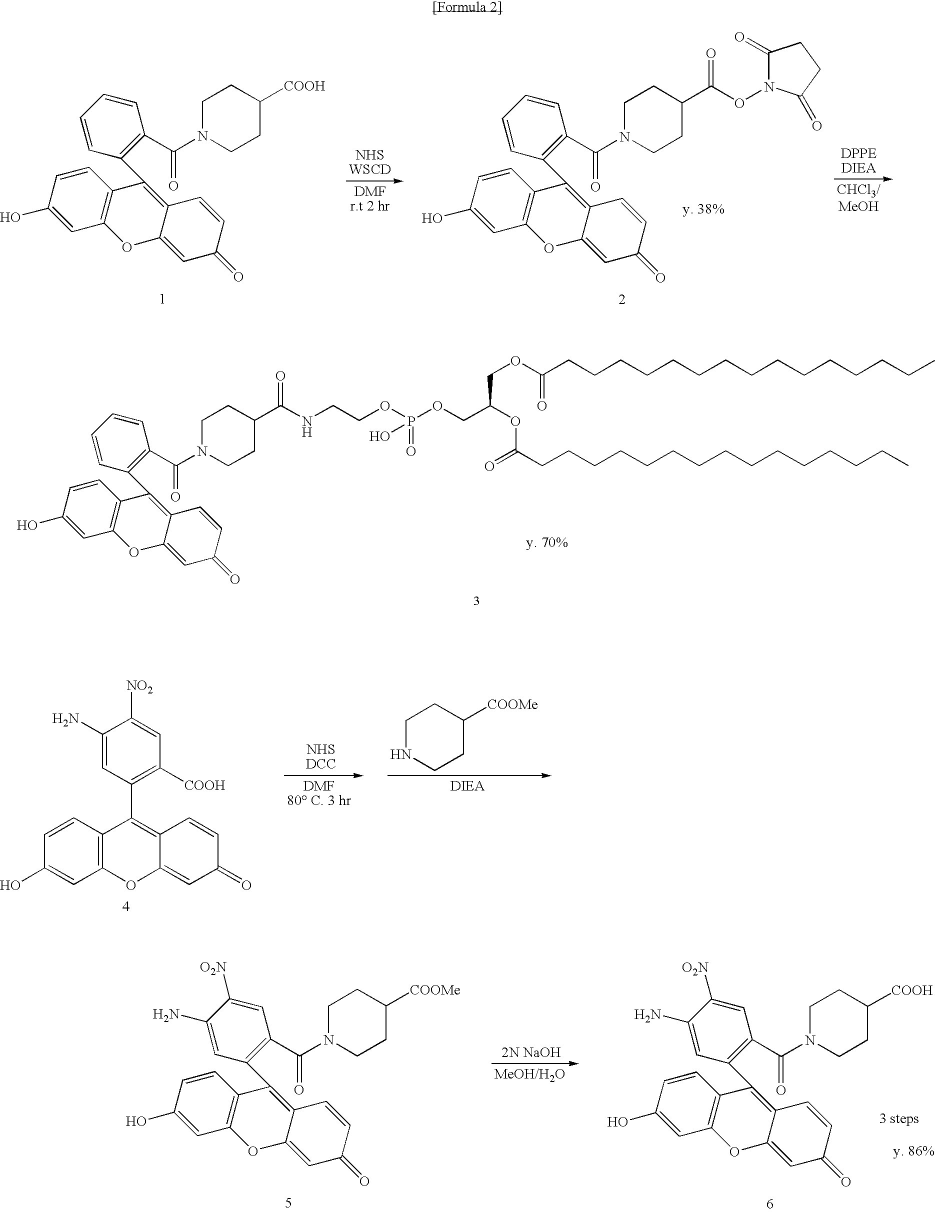

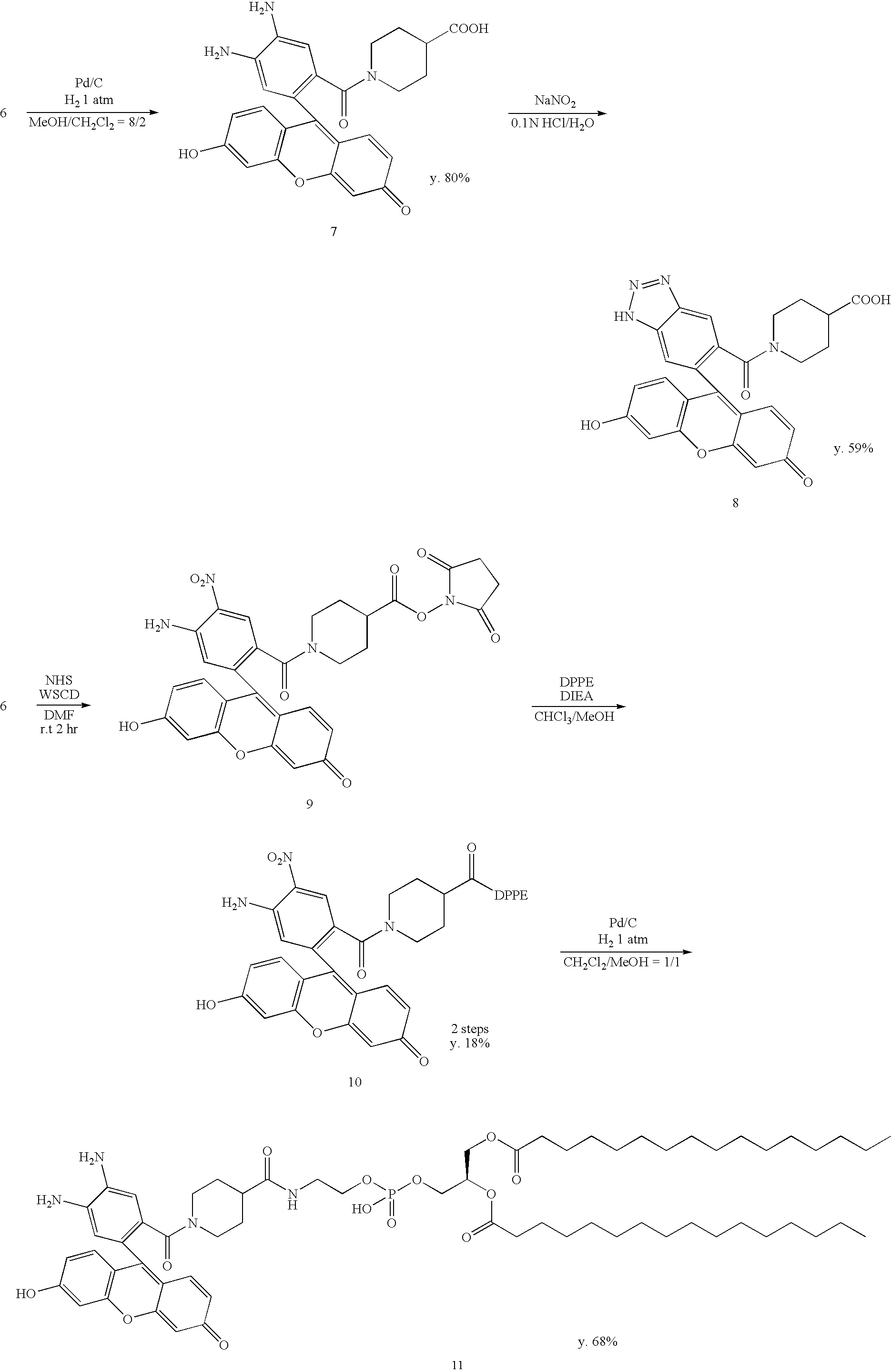

### (a) Synthesis of Compound 2

Compound 1 (30 mg, 0.068 mmol) was dissolved in distilled dimethyl sulfoxide (DMSO) (2 mL). In an ice bath, N-hydroxysuccinimide (NHS, 9.4 mg, 0.081 mmol) and 1-ethyl-3-(3-dimethylaminopropyl)-carbodiimide (WSCD, 15.6 mg, 0.081 mmol) were added to the solution, and the mixture was stirred under an argon atmosphere at 0° C. for 30 minutes, and subsequently stirred at room temperature for 30 minutes. Next, NHS (5 mg, 0.043 mmol) and WSCD (10 mg, 0.052 mmol) were added to the mixture, then the mixture was further stirred at room temperature for 1 hour. The solvent was evaporated under reduced pressure, and the residue was purified by silica gel chromatography (5% methanol/95% dichloromethane) to obtain Compound 2 (12 mg, yield: 33%).

¹H-NMR (300 MHz, DMSO-d₆) δ (ppm) 1.30 (br, 2H), 1.79 (br, 2H), 2.54 (br, 1H), 2.70 (br, 1H), 2.79 (s, 4H), 2.97 (br, 1H), 3.54 (br, 1H), 3.92 (br, 1H), 6.56 (d, 4H, J=8.4 Hz), 6.94 (d, 2H, J=8.4 Hz), 7.43 (m, 1H), 7.57 (m, 1H), 7.66 (m, 2H)

MS (ESI+) 540 (M+H)

### (b) Synthesis of Compound 3 (FL-PIP-DPPE)

Dipalmitoylphosphatidylethanolamine (DPPE, 14 mg, 0.020 mmol) was dissolved in a solvent (distilled chloroform/distilled methanol=2/1), and to the solution was added diisopropylethanolamine (DIEA, 3.4 μL, 0.020 mmol). To this reaction mixture was slowly added dropwise Compound 2 (10 mg, 0.019 mmol) dissolved in methanol over 1 hour. Then, the mixture was stirred at room temperature for 4.5 hours. The reaction mixture was added with chloroform, then washed with water acidified with hydrochloric acid. The solvent was evaporated under reduced pressure, then the residue was purified by reverse phase silica gel chromatography (30% methanol/70% water to 90% methanol/10% water) to obtain Compound 3 (14.5 mg, yield: 70%).

¹H-NMR (300 MHz, DMSO-d₆) δ (ppm) 0.88 (t, 6H, J=6.8), 1.27 (br, 50H), 1.60 (br, 4H), 1.80 (br, 2H), 2.32 (m, 5H), 2.61 (br, 1H), 3.10 (br, 1H), 3.46 (br, 2H), 3.51 (br, 2H), 3.95 (br, 1H), 4.02 (br, 2H), 4.22 (br, 2H), 4.43 (br, 1H), 5.24 (br, 1H), 7.00 (d, 4H, J=8.6 Hz), 7.41 (d, 2H, J=8.6 Hz), 7.45 (m, 1H), 7.66 (m, 1H), 7.75 (m, 2H)

HRMS (ESI+) calcd for C₆₃H₉₄N2O₁₃P₁ 1117.6494 (M+H). found 1117.6504

### (c) Synthesis of Compound 6

Compound 4 (200 mg, 0.51 mmol), NHS (117 mg, 1.0 mmol), and N,N′-dicyclohexylcarbodiimide (DCC, 210 mg, 1.0 mmol) were dissolved in distilled dimethylformamide (1 mL), then the solution was stirred at 80° C. for 50 minutes in an argon atmosphere. The reaction mixture was cooled to room temperature, to which were added isonipecotinic acid methyl ester (206 μL, 1.53 mmol) and DIEA (252 μL, 15.3 mmol), and the mixture was stirred at room temperature for 3 hours. After the solvent was evaporated, the crude product separated by silica gel chromatography (7% methanol/93% dichloromethane) was suspended in methanol/water=1/1 solvent (20 mL). Next, to the suspension was added 2 mol/L aqueous sodium hydroxide (2 mL), and the mixture was stirred at room temperature for 1.5 hours. After completion of the reaction, the reaction mixture was neutralized with 2 mol/L hydrochloric acid, and then the solvent was evaporated. The residue was purified by silica gel chromatography (7% methanol/93% dichloromethane to 25% methanol/75% dichloromethane) to obtain Compound 6 (220 mg, yield: 86%).

¹H-NMR (300 MHz, DMSO-d₆) δ (ppm) 1.23 (br, 2H), 1.68 (d, 2H, J=12.4 Hz), 2.34 (br, 1H), 3.83 (d, 2H, J=12.6 Hz), 4.10 (br, 2H), 6.44 (s, 2H), 6.50 (d, 2H, J=9.5 Hz), 6.99 (s, 1H), δ7.05 (d, 2H, J=9.5 Hz), 7.80 (br, 2H), 8.06 (s, 1H)

MS (ESI+) 504 (M+H)

### (d) Synthesis of Compound 7 (DAF-piperidinic Acid, DAF-PIPA)

Compound 6 (20 mg, 0.040 mmol) was dissolved in methanol/dichloromethane=8/2 solvent (4 mL), and to the solution was added palladium/carbon (Pd—C, 2%), and the mixture was stirred for 30 minutes in a hydrogen atmosphere (1 atm). The reaction mixture was filtered through Celite to remove Pd—C, and then the filtrate was concentrated to obtain Compound 7 (15 mg, yield: 80%).

¹H-NMR (300 MHz, DMSO-d₆) δ (ppm) 1.22 (br, 2H), 1.65 (d, 2H, J=12.0 Hz), 2.30 (br, 1H), 3.80 (d, 2H, J=12.0 Hz), 4.09 (br, 2H), 5.04 (br, 4H), 6.46 (s, 2H), 6.47 (d, 2H, J=2.1 Hz), 6.51 (dd, 2H, J=9.2 Hz, 2.1 Hz), 6.66 (s, 1H), 7.12 (d, 2H, J=9.2 Hz)

HRMS (ESI+) calcd for C₂₆H₂₄N₃O₆ 474.1665 (M+H). found 474.1714

### (e) Synthesis of Compound 8

Compound 7 (20 mg, 0.042 mmol) was dissolved in water acidified with hydrochloric acid, and to the solution was slowly added dropwise aqueous sodium nitrite (3 mg, 0.042 mmol) in an ice bath, then the mixture was stirred at room temperature for 30 minutes. After the reaction mixture was neutralized with 2 mol/L aqueous sodium hydroxide, the solvent was evaporated, and the residue was purified by reverse phase silica gel chromatography (100% water). The product purity was confirmed by ODS column HPLC (12 mg, yield: 59%).

HRMS (ESI−) calcd for C₂₆H₁₉N₄O₆ 483.1305 (M+H). found 483.1329

HPLC (Eluent A/B=80/20 (0 minute), 60/40 (10 minutes))

Eluent A=Water (containing 0.1% trifluoroacetic acid)

Eluent B=Acetonitrile/water (containing 0.1% trifluoroacetic acid)=80/20

### (f) Synthesis of Compound 10

First, Compound 9 was synthesized from Compound 6 in the same manner as that of the synthesis of Compound 2 from Compound 1. Then, Compound 10 was synthesized from Compound 9 in the same manner as that of the synthesis of Compound 3 from Compound 2. Purification was performed by silica gel chromatography (15% methanol/85% dichloromethane, yield from Compound 6: 18%). ¹H-NMR (300 MHz, CDCl₃/CD₃OD=1/1) δ (ppm) 0.89 (t, 6H, J=6.8 Hz), 1.27 (br, 50H), 1.60 (br, 4H), 1.76 (d, 2H, J=11.9 Hz), 2.32 (m, 5H), 3.41 (br, 2H), 3.67 (br, 2H), 3.89 (br, 2H), 3.98 (t, 2H, J=5.7 Hz), 4.17 (br, 2H), 4.18 (dd, 1H, J=12.1 Hz, 5.7 Hz), 4.41 (dd, 1H, J=12.1 Hz, 3.5 Hz), 5.25 (br, 1H), 6.72 (s, 2H), 6.81 (br, 2H), 7.02 (s, 1H), 7.25 (d, 2H, J=9.2 Hz), 8.26 (s, 1H)

HRMS (ESI−) calcd for C₆₃H₉₂N₄O₁₅P₁ 1175.6297 (M−H). found 1175.6265

### (g) Synthesis of Compound 11 (DAF-PIP-DPPE)

Compound 10 (14 mg, 0.012 mmol) was dissolved in 4 mL of a solvent (methanol/dichloromethane=1/1), and to the solution was added Pd—C (2%), and the mixture was stirred for 30 minutes in a hydrogen atmosphere (1 atm). The reaction mixture was filtered through Celite to remove Pd—C, and the filtrate was concentrated to obtain Compound 11 (9 mg, yield: 68%).

¹H-NMR (300 MHz, CDCl₃/CD₃OD=1/1) δ (ppm) 0.88 (t, 6H, J=7.0 Hz), 1.27 (br, 50H), 1.61 (br, 4H), 1.80 (d, 2H, J=12.9 Hz), 2.32 (m, 5H), 3.41 (br, 2H), 3.67 (br, 2H), 3.96 (br, 2H), 4.03 (t, 2H, J=5.9 Hz), 4.18 (dd, 3H, J=12.1 Hz, 5.9 Hz), 4.43 (dd, 1H, J=12.1 Hz, 3.5 Hz), 5.25 (br, 1H), 6.73 (s, 2H), 6.95 (s, 2H), 7.17 (s, 2H), 7.27 (br, 2H), 7.77 (d, 2H, J=9.4 Hz)

HRMS (ESI+) calcd for C₆₃H₉₄N₄O₁₃P₁ 1145.6555 (M−H). found 1145.6555

### Example 2

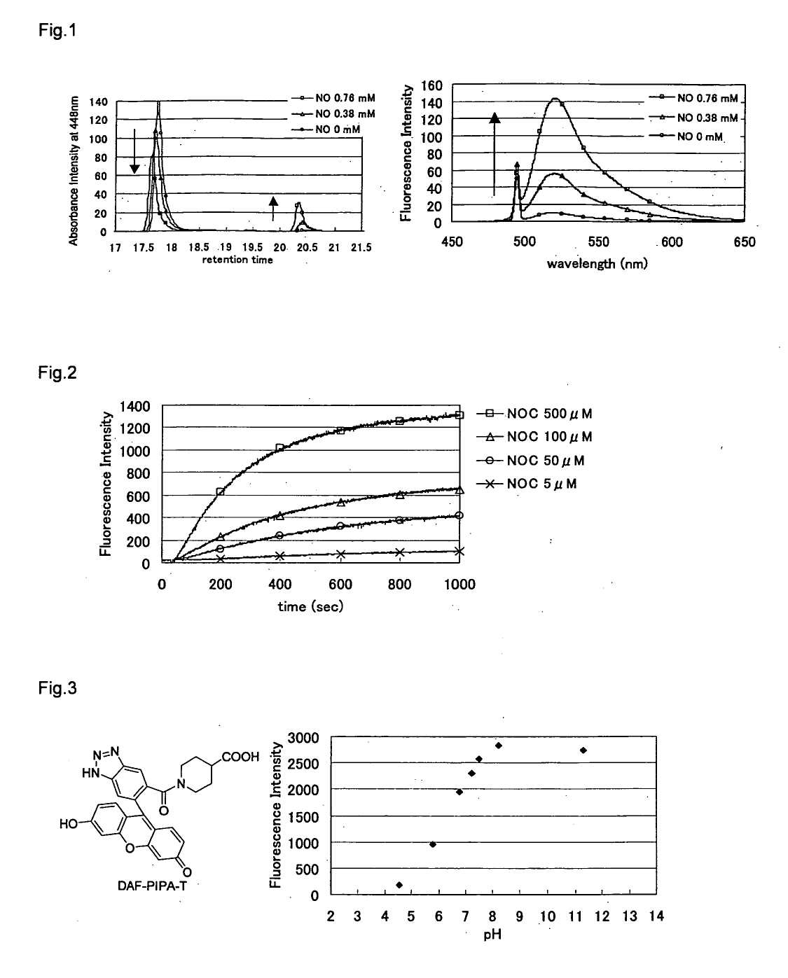

Nitric oxide (NO) was added to 2 mmol/L DAF-PIPA aqueous solution so that the NO concentration became 0.38 mmol/L and 0.76 mmol/L, then the reaction was monitored by HPLC. Further, the mixture was diluted 1000 times with a sodium phosphate buffer to measure fluorescence (excitation wavelength: 498 nm, emission wavelength: 521 nm). In HPLC analysis, the retention time of DAF-PIPA is 17.3 minutes. After the reaction of DAF-PIPA with NO, a substance having a retention time of 20.3 minutes was produced. This substance was confirmed with ESI-MS to be a triazole form, DAF-PIPA-T, which was produced by the reaction of the diamino moiety of DAF-PIPA with NO (FIG. 1).

To a 1.27 μmol/L DAF-PIPA PBS(−) solution at 37° C. was added NOC13 as a sustained release-type NO releasing agent at concentrations of 5 μmol/L, 50 μmol/L, 100 μmol/L, and 500 μmol/L, respectively, and change in the reaction with NO over time was measured. The fluorescence intensity was found to became larger in a NO concentration-dependent manner (FIG. 2).

A pH profile for fluorescence intensity of the fluorescent substance DAF-PIPA-T as the product of the reaction with NO is shown. The fluorescence intensity depended on the state of phenolic hydroxyl group in the xanthene moiety, and pKa of phenolic hydroxyl group was about 6.3 (FIG. 3).

### Example 3

### (a) Confirmation of Existence of Membrane Anchoring-Type Fluorescent Probe in Membrane

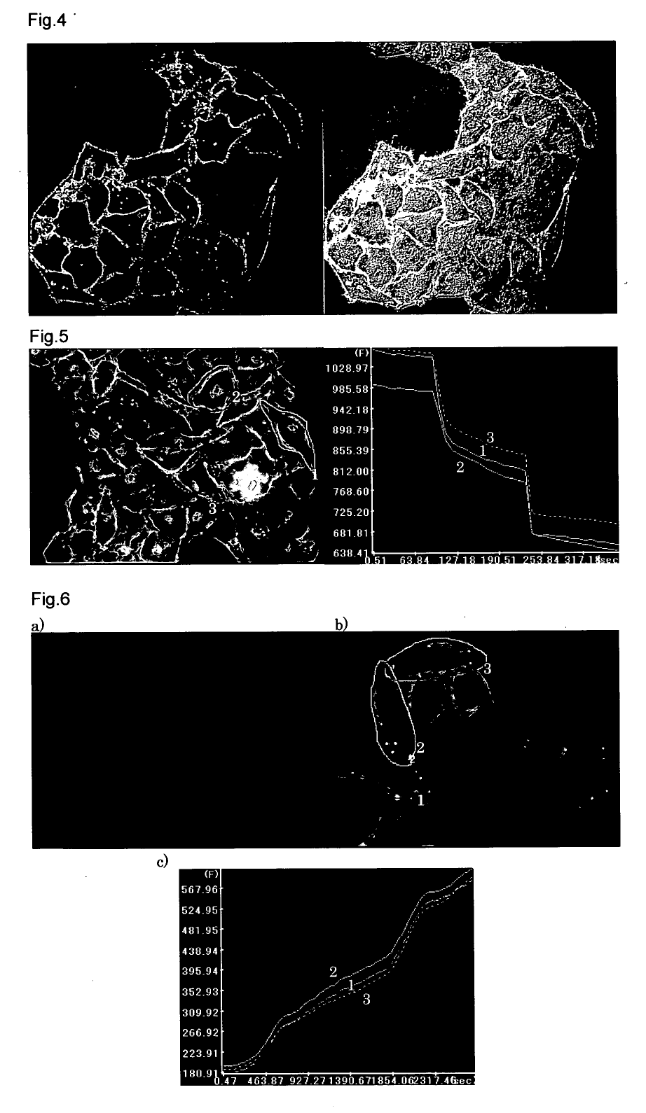

The fluorescence intensity of DAF-PIP-DPPE is weak before the reaction with NO. Therefore, considering the easiness of observation, it was decided to perform the confirmation by using FL-PIP-DPPE which binds fluorescein and to provide strong fluorescence intensity. A 10 μmol/L solution of FL-PIP-DPPE in DMEM (serum free, containing 1% DMSO) was used as a cell culture medium for the HeLa cells, and the culture was left standing at 22° C. for 10 minutes. Then, the cell culture medium was exchanged for a PBS(+) solution, pH 7.4, and the cells were observed by using a confocal laser scanning microscope (×60), which enables fluorescence observation of cell slices along the optical axis direction. Fluorescence of FL-PIP-DPPE was observed to be distributed over the cell membranes, and thus FL-PIP-DPPE was confirmed to be localized on the cell membranes (FIG. 4).

### (b) Verification of the Amount of Fluorochrome Moiety Existing Inside and Outside of Cell Membrane

To an extracellular fluid of the cells loaded with FL-PIP-DPPE (pH 7.4, PBS(+), 1 mL) was added PBS(+), pH 4.5 in 500 μ/L portions in order to change pH of the extracellular fluid from 7.4 to 6.7 to 6.4; and changes in fluorescence intensity were observed with a fluorescence microscope (FIG. 5). The fluorescence intensity of fluorescein changes in a pH-dependent manner similar to that shown in FIG. 3. When the fluorochrome moiety exists on the outside of the cells, the fluorescence intensity of FL-PIP-DPPE is expected to change with pH change in a manner substantially similar to that shown in FIG. 3, and thus the fluorescence should decrease. The decrease was observed as expected. Fluorescence intensity decreased by 40% according to the pH change of the extracellular fluid, and this value corresponds to the shrinkage by 40% observed in the fluorescence intensity change in the pH profile shown in FIG. 3.

As a control experiment, a fluorescein ester derivative (fluorescein diacetate), which can penetrate cell membranes and undergo hydrolysis by cytoplasmic esterase to distribute fluorescein intracellularly, was loaded on the cells, then the cells were treated in the same manner. As a result, no change in fluorescence intensity according to the pH change was observed. Thus, intracellular pH is considered to be hardly affected by extracellular fluid pH change. Regarding the previously mentioned FL-PIP-DPPE, if the fluorescein moiety thereof was intracellularly uptaken after loaded on the outside of the cell membrane, fluorescence intensity would not decrease as much as 40%, correspondingly to the pH profile. Therefore, it was confirmed that the fluorescein moiety of FL-PIP-DPPE existed on the outside of the cell membrane.

According to the above studies, it is confirmed that the fluorescein moiety of the membrane anchoring-type fluorescent probe does not penetrate cell membranes. Therefore, it is confirmed that when the membrane anchoring-type fluorescent probe is loaded on the outside of a cell membrane by a method of dissolving the probe in an extracellular fluid or the like, observation of a target substance on the outside of the cell membrane is achievable. On the other hand, when the membrane anchoring-type fluorescent probe is loaded into the inside of a cell membrane by microinjection or the like, observation of a target substance of the inside of the cell membrane is achievable.

### (c) Function as NO Probe on Cell Membrane

To 1 mL of an extracellular fluid (pH 7.4, PBS (+)) loaded with DAF-PIP-DPPE (7.5 μmol/L) was added NOC13 solution (500 μL) prepared before use. The NOC13 concentration was 100 μmol/L at 120 seconds after the start of the observation, and 1 mmol/L at 1,800 seconds, and fluorescence intensity changes at those time points were observed with a fluorescence microscope. Marked increase in the fluorescence intensity was observed on the cell membranes, and thus the probe was confirmed to function as an NO probe on HeLa cell membranes (FIG. 6).

### INDUSTRIAL APPLICABILITY

By using the fluorescent probe of the present invention, the movement of a target substance from inside to outside of a cell, the movement of an target intercellular signal transduction substance and the like can be observed.

1. A membrane anchoring-type fluorescent probe consisting of a compound comprising a phospholipid residue, a fluorescent probe compound residue, and a linker which binds the residues.

2. The membrane anchoring-type fluorescent probe according to claim 1, which is represented by the following formula. [chemical structure]
